(19) United States
(12) Patent Application Publication
(10) Pub. No.: US 2004/0001055 A1
(43) Pub. Date: Jan. 1, 2004

(54) Mechanism for releasably storing a display device and a car radio provided with such mechanism

(75) Inventor: David Yeo Wee Kiang, Singapore (SG)

Correspondence Address: Thomas C. Pontani, Esq., Cohen, Pontani, Lieberman & Pavane, 551 Fifth Avenue, Suite 1210, New York, NY, 10176, US

(73) Assignee: Siemens Aktiengesellschaft

(21) Appl. No.: 10/610,738

(22) Filed: Jun. 30, 2003

Related U.S. Application Data
(60) Provisional application No. 60/392,466, filed on Jun. 28, 2002.

(51) Int. Cl. G09G 5/00

(52) U.S. Cl. 345/205

(57) ABSTRACT

A mechanism for storing and ejecting a display device pertaining to a car information output apparatus includes an insert device allowing insertion of the display device into the mechanism, the insert device including a bracket frame and a bracket base, the bracket base being connectable to the display device. A guide device provides two-way guidance for the insertion of the display device along a substantially linear path between an eject position and a store position. Compression springs are arranged for exerting an ejecting force on said insert means. A locking device releasably locks the insert means in the store position against the ejecting force. The springs include a first compression spring having first and second ends and a second compression spring having first and second ends. An intermediate member is connected to the second end of the first compression spring and the first end of the second compression spring, so that relative travel between said first end of said first compression spring and said second end of said second compression spring determines an overall movement of the display device.

### RELATED APPLICATIONS

This application claims priority from U.S. Provisional Patent Application Serial No. 60/392,466 which was filed on Jun. 28, 2002.

### BACKGROUND OF THE INVENTION

1. Field of the Invention

The invention relates to a mechanism for releasably storing a display device in a car information output apparatus, the mechanism including a guide providing two-way guidance of insertion of the display device along a substantially linear insertion path, a spring for exerting an ejecting force on the display device, an insert device allowing insertion of said display device into said mechanism under control of an external force, and a lock device for locking the display device after insertion of the display device to a stored position.

2. Description of the Related Art

Many car information output apparatuses such as car radios and route planning systems include a display device providing information such as pertaining to the car proper or to other information. The display device may, for example, be in the form of a Liquid Crystal Display (LCD) screen, a Thin-Film Transistor (TFT) screen, a Touch-screen or an Organic Light-Emitting Diode (OLED) screen.

It has been found necessary to allow reversibly or releasably storing of such a display device within a space in an enclosure of the car information output apparatus and to subsequently allow ejecting the display device out from the enclosure. The ejecting may be required for repair, maintenance, and other purposes such as security. Such storing mechanisms have been configured with an electromechanical system including batteries, motors, gears, printed circuit boards, wires, a mechanical frame, and further parts. Such an electromechanical system can have various different constructions, and can in particular, store and subsequently discharge a substantial amount of energy to the system to displace the display device during insertion and during ejection, respectively, resulting in a complex system. Such complexity is a marked disadvantage.

It is, in principle, possible to apply a single long compression spring to store and subsequently relieve compression energy instead of relying on the electromechanical system. The inventor has recognized that such long spring will easily buckle and fail to be compressed according to its original intent.

### SUMMARY OF THE INVENTION

It is an object of the present invention to provide a configuration to store and subsequently relieve compression energy in a mechanism for releasably storing a display device in a car information outputting enclosure that overcomes the problems of the prior art. To achieve the object, the inventor has recognized the possibility to use two compression strings mounted in series. The use of two separate compression springs allows the individual, separate lengths to be made shorter to appreciably reduce the buckling effect.

The mechanism according to the present invention includes a first compression spring having a first end and a second end and a second compression spring having a first end and a second end. The mechanism further includes an intermediate member that joins said second end of the first compression spring to the first end of the second spring, so that relative travel between said first end of the first spring and said second end of the second spring determines an overall movement of said display device.

In an embodiment of the invention, the first compression spring has a first guide device that is incorporated in a bracket frame and a bracket sleeve (the intermediate member) of the mechanism. The second compression spring has a second guide device that rests on a bracket base at a first end of the second compression spring, the other end of the second spring being guided by a tubular construction connected to the bracket sleeve. The second guide device may comprise a spindle guide.

The bracket base, second guide device and bracket sleeve are telescopically slidable into each other for compactness.

The first and second compression springs are preferably screw springs.

In an alternative embodiment of the present invention, the first and second compression springs are laterally disposed with respect to each other.

The present invention also relates to a car radio with a mechanism for storing therein a display device as described above.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1a is a front view of an embodiment of a display device according to the present invention;

FIG. 1b is a side view of the display device of FIG. 1a;

FIG. 1c is a top perspective view of the display device of FIG. 1a;

FIG. 1d is a bottom view of the display device of FIG. 1a;

FIG. 2a is a top view of a typical car radio enclosure;

FIG. 2b is a perspective view of the car radio enclosure of FIG. 2a;

FIG. 2c is a front view of the car radio enclosure of FIG. 2a;

FIG. 2d is a side view of the car radio enclosure of FIG. 2a;

FIG. 3 is a partial sectional view of a two-stage ejection system embodiment according to the present invention in which the display device is inserted from the right side of the drawing;

FIGS. 4a and 4b are side sectional views of the first mechanism of the ejection system of FIG. 3 in eject mode and in store mode, respectively;

FIGS. 5a and 5b are side sectional views of the second mechanism of the ejection system of FIG. 3 in eject mode and in store mode, respectively;

FIG. 6 is a partial reverse view of the embodiment of FIG. 3, wherein the display device is inserted from the left side of the drawing;

FIG. 7 is a further partial view corresponding to FIG. 6.

### DETAILED DESCRIPTION OF THE PRESENTLY PREFERRED EMBODIMENTS

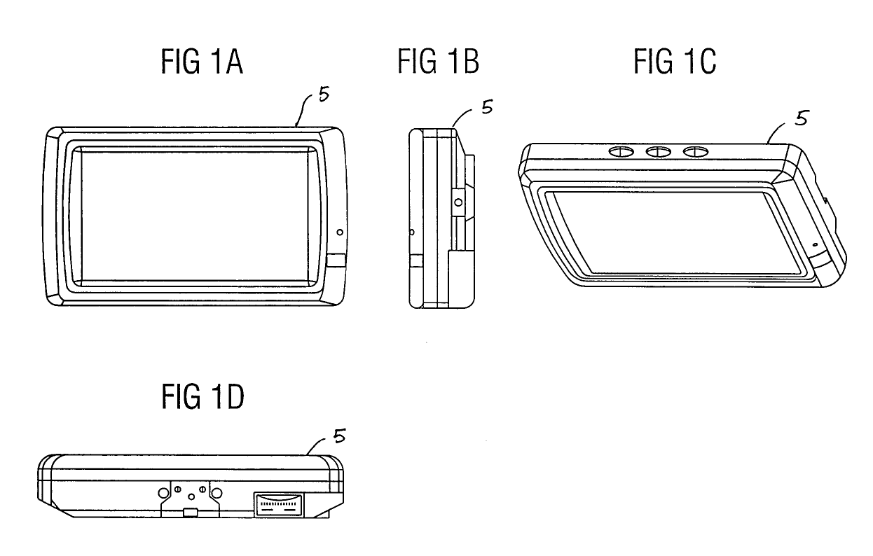

FIGS. 1a-1d illustrate an example of a display device 5 for use in a car radio or similar car-based information output apparatus. Herein, FIG. 1a is a front view of display device 5. Such display may accommodate a few lines of characters, radio station information, a road map, iconized representations of car-internal or car-external situations, or other images and/or text. Display device 5 may have various sizes such as, without being restricted to, 3×5 centimeters in a relatively small display or 12×15 centimeters in a larger one. FIG. 1b shows a plan view of the shorter side of display device 5 and FIG. 1d is a plan view of the longer bottom side of the display device. Finally, FIG. 1c is a perspective view of the display device. As marketed, such displays may come with drivers, decoders, power supply, data storage, and various other subsystems and peripherals that will not be further herein considered for brevity.

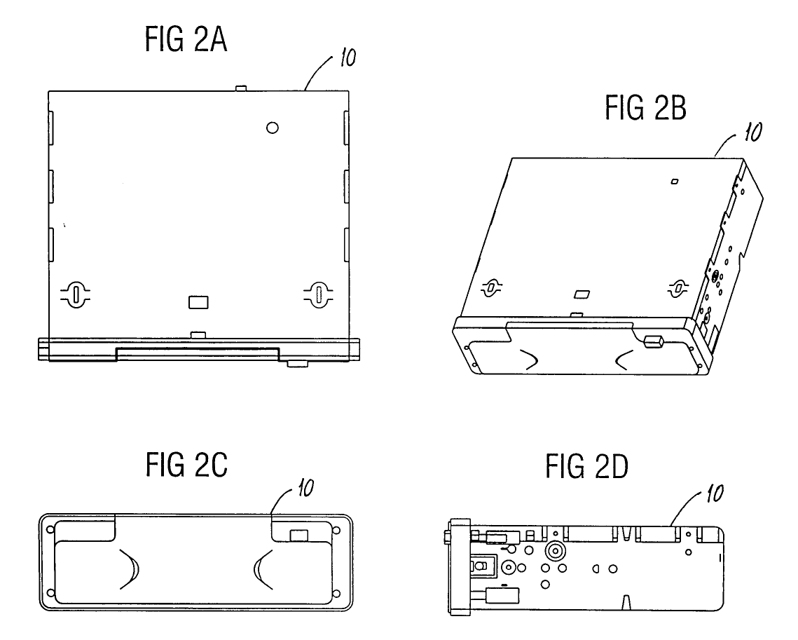

FIGS. 2a-2d illustrate a typical car radio enclosure 10. FIG. 2a shows a top plan view of enclosure 10, together with indications of the size thereof: 178.6 by 150.6 millimeters. Of course, the enclosure may be any size required for particular application in which the enclosure is used. FIG. 2c is a front view of enclosure 10, with display device 5 in place. FIG. 2d is a side view and FIG. 2b is a perspective view of car radio enclosure 10. For brevity, no further details on either the enclosure proper, or on the car radio functionality, are given here, apart from such internal constructive details as presented hereinafter.

Prior art mechanisms for providing the functions of storing and ejecting the display device which include a single compression spring are prone to the following two main problems: (1) buckling of the compression spring and (2) over-pitching of the compression spring.

Regarding the first problem, movement of the display device by more than half its length outside the car radio enclosure requires a long compression spring. Such long compression spring will increase the tendency of the spring to buckle. This buckling effect will hinder both the natural operation of the spring and will reduce its reliability, and therefor, of the overall system as well.

Regarding the second problem, the display device, whether it is based on LCD, TFT, Touch-screen, or OLED technology, is a relatively heavy component. To then effectively move the display device, a high spring force is required. A sufficiently high force can be realized by a spring with greater pitch. However, the over-pitching of such a spring will subject the spring to excessive stress which can reduce fatigue resistance.

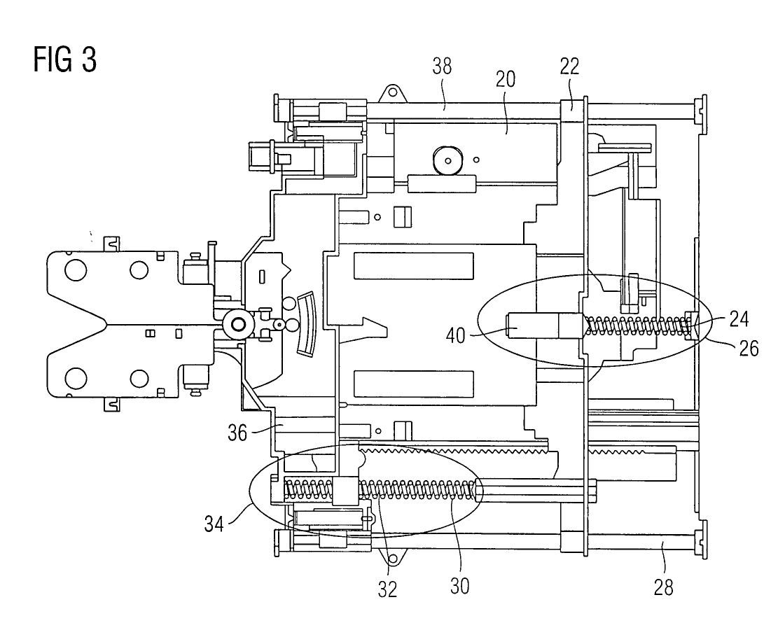

FIG. 3 shows a two-stage ejection system embodiment according to the present invention. For brevity, the display device itself, which is connectable at the left side of the system in FIG. 3, has not been shown. The inserting force is applied from the left hand side. The mechanism is built within a bracket frame 20 that houses the various other moving parts. For the greater part, other parts shown but not related to the invention proper, have not been discussed for reasons of brevity and clearness. Now in particular, the moving parts have been configured into a two-stage ejection sub-system. These moving parts comprise a first sub-system 26 and a second subsystem 34. The first sub-system 26 includes the bracket frame 20, a bracket sleeve 22, and a first compression spring 24. The second sub-system 34 includes a bracket base 36, a spindle guide 32, a second compression spring 30, and the bracket sleeve 22.

The desired ejection distance of the display device is comprised of the combined length of first and second compression springs 24, 30. This approach eliminates the need for a single long spring to achieve the desired ejection length. In the first sub-system 26, additional guides 40 for the first compression spring 24, are incorporated into both bracket frame 20 and bracket sleeve 22 to further reduce the tendency of the first compression spring 24 to buckle. A locking mechanism for keeping the display in its inserted position includes a latching mechanism including latching element 70. The relieving mechanism for the locking mechanism is not shown.

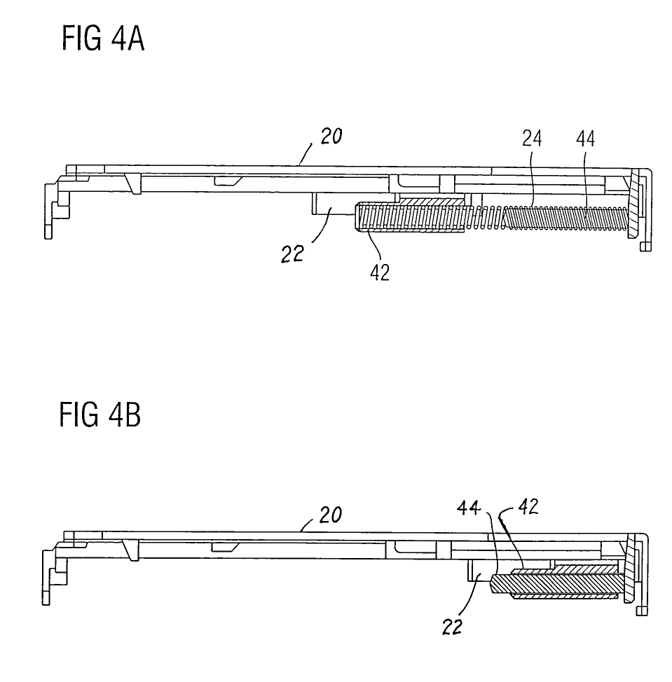

FIGS. 4a, 4b show side views of the first sub-system 26 in an ejected mode and in stored mode, respectively. As shown in FIG. 4a, the first sub-system 26 includes an internal guide 44 and an external guide 42, each connected to part of the first compression spring 24. In the stored mode shown in FIG. 4b, the two guides slide into each other telescopically, to thereby minimize the space taken up when the display device is stored within the car radio enclosure.

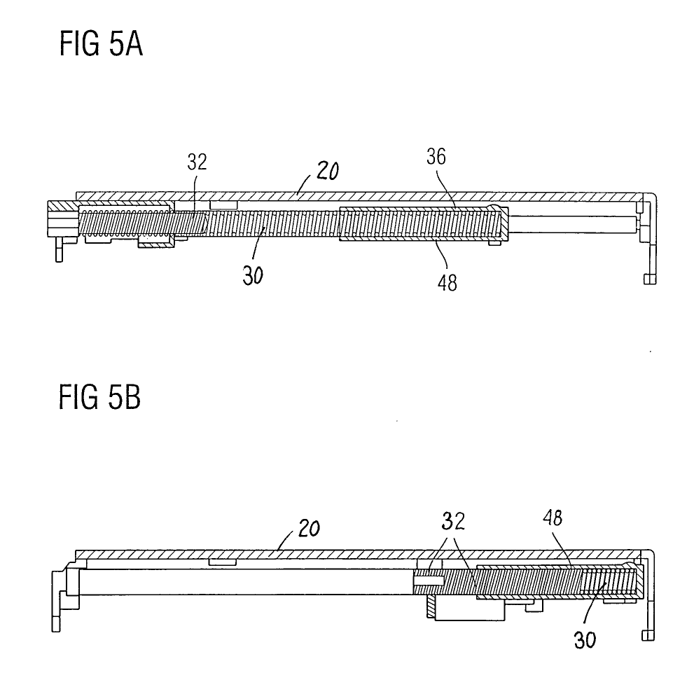

FIGS. 5a, 5b show the second sub-system 34 in ejected mode and in the stored mode, respectively. An additional spindle guide 32 connected to bracket base 36 guides the end of the second compression spring 30 which rests on the bracket base 36. The other end of the second compression spring 30 is guided by a tubular construction 48 projecting from the bracket sleeve 22. To achieve maximum compactness, bracket base 36, spindle guide 32, and bracket sleeve 22, have each been shaped so as to slide into each other telescopically.

The high energy needed to eject the display device is distributed among the first and second compression springs 24, 30. Because the first and second compression springs are relatively short compared to the total ejection distance, a greater-diameter spring wire may be used for attaining higher stiffness while simultaneously minimizing the probability and effect of buckling.

The configuration of the present invention allows the spring force to have a greater adjustability along with a variation in the spring wire diameter compared to varying the compression spring pitch. As such, the pitch of the first and second compression springs may be designed to the minimum value for achieving a more reliable spring life.

The bracket base 36 runs on first and second hard-chrome plated spindles 28, 38 mounted on the bracket frame 20 (see FIGS. 4a, 5a). The bracket base 36 houses an attachment to secure the display device which, as described above, may be an LCD, TFT, Touch-screen, or OLED display.

The bracket base 36 slides with close fit along spindle 28 while a larger clearance is specified between spindle 38 and the bracket base 36. The close fit between spindle 28 and bracket base 36 provides a good reference during the ejection of the display device mounted on the two-stage ejection mechanism.

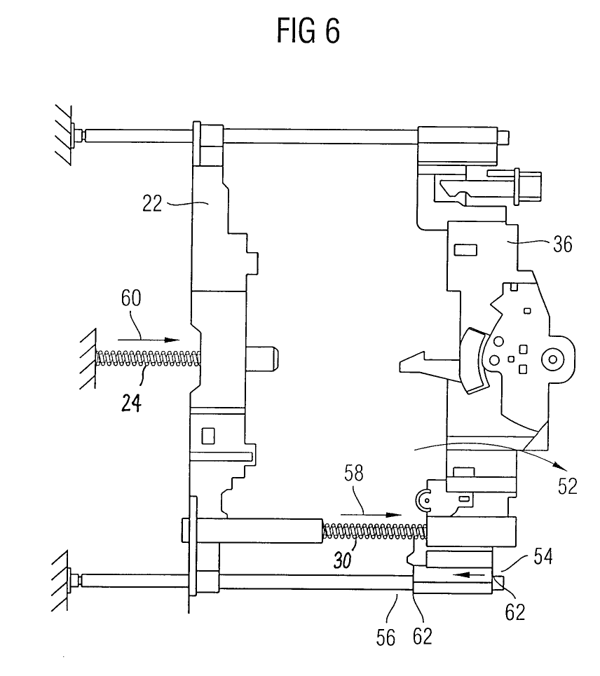

FIG. 6 is a further view of the mechanism according to the present invention. The position of the mechanism depicted in FIG. 6 is reversed relative to the position of the mechanism shown in FIG. 3. That is, the inserting force in FIG. 6 is applied from the right side. FIG. 6 indicates a force 58 from second compression spring 30, force 60 from first compression spring 24, and opposing frictional forces 54, 56 on the contact points 62 between spindle 28 and bracket base 36. Second compression spring 30 has been located as close as possible to first spindle 28 to minimize the torque 52 applied on first spindle 28 by the spring force of the second compression spring 30, thereby minimizing the reaction or friction force between first spindle 28 and the sliding surface of the bracket base 36. The effect is to minimize both static and dynamic friction at the point of contact between spindle 28 and bracket base 36. This minimization of friction contributes to the optimal sliding condition for the bracket base 36.

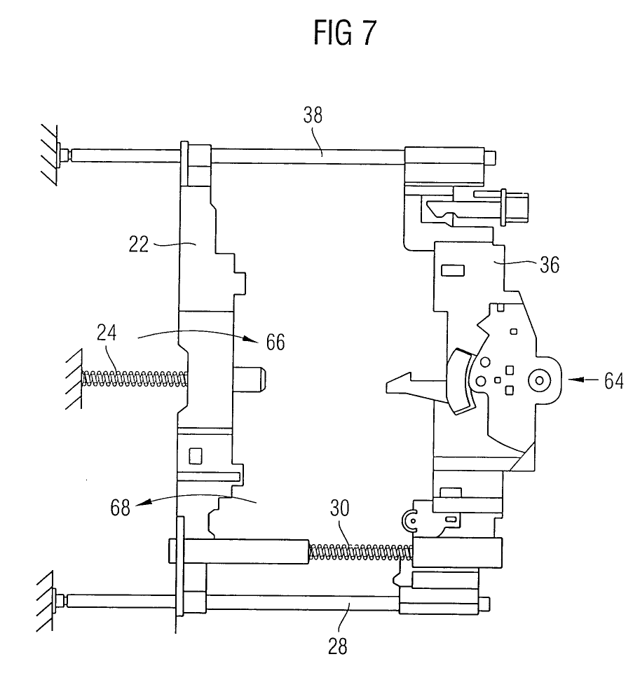

FIG. 7 is a further view of the mechanism according to the present invention in the same orientation as FIG. 6. In FIG. 7, an arrow 64 indicates an inserting force. When the mechanism is operated by pushing the bracket base 36 toward the ‘Lock’ position shown in FIGS. 4b, 5b, the second compression spring 30 creates a torque 68 on the bracket sleeve 22 on the side close to first spindle 28. The first compression spring 24 has been located at the center of the bracket sleeve 22 such that the first compression spring 24 creates a counter-balance torque 66 to counter the torque 68.

The two sub-systems 26, 34 have been fine-tuned, in terms of force, to provide an optimized friction condition for all sliding components mounted on the mechanism. The locations of both sub-systems 26, 34 have been designed to minimize the loss of force needed to eject the display device. This further lowers the force requirements on the ejection spring system.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A mechanism for storing and ejecting a display device for a car information output apparatus, said mechanism comprising:
insert means for allowing insertion of the display device into said mechanism, said insert means including a bracket frame and a bracket base, said bracket base being connectable to the display device and movable relative to said bracket frame;
a guide device providing two-way guidance for the insertion of the display device along a substantially linear path between an eject position and a store position;
spring means for exerting an ejecting force on said insert means; and
a locking device releasably locking the insert means in the store position against the ejecting force, said spring means comprising a first compression spring having first and second ends, a second compression spring having first and second ends, and an intermediate member connected to the second end of the first compression spring and the first end of the second compression spring, so that relative travel between said first end of said first compression spring and said second end of said second compression spring determines an overall movement of the display device.

2. The mechanism of claim 1, wherein said spring means further comprises a first spring guide incorporated in both said bracket frame and said intermediate member.

3. The mechanism of claim 1, wherein said spring means further comprises a second spring guide for said second compression spring having a first guide part resting on said bracket base and a tubular construction projecting from said intermediate member.

4. The mechanism of claim 3, wherein said bracket base, said first guide part and said tubular construction of said intermediate member are telescopically receivable into each other for compactness.

5. The mechanism of claim 1, wherein said mechanism is for a car radio.

6. The mechanism of claim 1, wherein said first and second compression springs are helical springs.

7. The mechanism of claim 1, wherein said first and second compression springs are laterally disposed with respect to each other.

8. The mechanism of claim 7, wherein said intermediate member is guided by said guide device, said first spring exerting a force creating a first torque on said intermediate member relative to said guide device and said second spring exerting a force creating a second torque on said intermediate member relative to said guide device, wherein said first torque force counters said second torque force.

9. The mechanism of claim 1, wherein said intermediate member is guided by said guide device.

10. A car radio provided with a mechanism for therein storing a display device, said mechanism comprising:
insert means for allowing insertion of the display device into said mechanism, said insert means including a bracket frame and a bracket base, said bracket base being connectable to the display device and movable relative to said bracket frame;
a guide device providing two-way guidance for the insertion of the display device along a substantially linear path between an eject position and a store position;
spring means for exerting an ejecting force on said insert means; and
a locking device releasably locking the insert means in the store position against the ejecting force, said spring means comprising a first compression spring having first and second ends, a second compression spring having first and second ends, and an intermediate member connected to the second end of the first compression spring and the first end of the second compression spring, so that relative travel between said first end of said first compression spring and said second end of said second compression spring determines an overall movement of the display device.
